(19) United States
(12) Patent Application Publication
(10) Pub. No.: US 2023/0249946 A1
(43) Pub. Date: Aug. 10, 2023

(54) Lifting Device for Confined Spaces

(71) Applicant: Darren Christopher Tanner, Mesa, AZ (US)

(72) Inventor: Darren Christopher Tanner, Mesa, AZ (US)

(21) Appl. No.: 18/163,972

(22) Filed: Feb. 3, 2023

Related U.S. Application Data
(60) Provisional application No. 63/267,602, filed on Feb. 6, 2022.

(51) Int. Cl. B66C 1/10

(52) U.S. Cl. CPC B66C 1/105

(57) ABSTRACT

A lifting fixture comprises a lifting affordance slidingly coupled to an upper horizontal beam assembly, a lower assembly comprising two spaced-apart horizontal beams defining an intervening gap, and a substantially vertical structural assembly connecting a first end of the upper beam assembly to a first end of the lower assembly. The horizontal beams include arrays of threaded holes for receiving various adapter plates. The first horizontal beam assembly comprises a motor driving a power threaded lead screw engaged to a lifting affordance such as a lifting eye. The motor may be controlled by wireless remote control. The lifting fixture allows lifting of an object stored beneath an overhead obstruction to be manipulated using a crane whose lifting axis is offset to the side of the overhead obstruction.

### CROSS-REFERENCE TO RELATED APPLICATION

This application claims the benefit of and priority to U.S. Provisional Patent Application 63/267,602 “Lifting Device for Confined Spaces,” filed 6 Feb. 2022. The entire contents of U.S. Provisional Patent Application 63/267,602 “Lifting Device for Confined Spaces,” filed 6 Feb. 2022 are incorporated into this document by reference.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The invention relates to a gripping and lifting fixture for manipulating and positioning objects which are normally preferred to be handled by an overhead crane but while access is obstructed by confining structures.

### BACKGROUND

For many reasons, replaceable equipment or spare components are often stored in enclosures which are confined spaces. Unfortunately, for heavy or bulky objects, the benefits of the enclosure such as protection from elements, visual organization, or security from theft or tampering are negated by the inconvenience of access for staging and lifting tools and fixtures.

For lifting objects stored under operating machinery, it is often inconvenient, impractical, or costly to halt production and remove the machinery or structures overhead to allow access for direct lifting means to access and attach to the component or object being sought. Thus there is a need for grappling and lifting fixtures for applying lifting forces to objects stored in confined spaces or underneath other structures without halting running processes to dismantle obstructions to direct lifting.

### BRIEF DESCRIPTION

A primary objective of the invention is to provide an indirect structural path to convey lifting and moving forces from conventional lifting devices to bear upon equipment stored in enclosures where direct access from above is obstructed by structures or equipment which is impractical to displace.

A corollary objective of the invention is to acquire vertical lifting forces from conventional lifting devices such as an overhead crane, direct the lifting force around an overhead obstruction, and apply it to the object being sought.

Another objective of the invention is to be able to attach to an object stored at a preferred orientation and be able to compensate for its mass so that while aloft and in motion the object retains its preferred orientation. A specific example of this objective is to be able to grab and lift an object stored in a level orientation, and then to lift and transport the object while maintaining it at level. A corollary objective of the invention is to translate the location of a lifting site to compensate for the shift in center of gravity between the lifting fixture in its unladen state and the lifting fixture engaged with a freight load.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1a shows an environmental view of a physical plant which includes conveying equipment and conveyor belts pulleys as stored components.

FIG. 1b shows an embodiment of a lifting fixture in accordance with the invention positioned to engage and raise a conveyor pulley from a storage location underneath a conveyor belt structure.

FIG. 1c shows the lifting fixture of FIG. 1b with the conveyor pulley raised up from its storage location and maintained level.

FIG. 1d shows the lifting fixture of FIG. 1b having successfully moved the conveyor pulley from an obstructed storage location to an open-area maintenance or inspection area.

FIG. 2 shows an oblique top front left view of an embodiment of a lifting fixture in accordance with the invention.

FIG. 3. shows the lifting fixture of FIG. 2 with its counterweight being a linear array of plates shown exploded in this view, and one of its two hoists and one of its beam tip hoist adapter fixtures exploded from its lower horizontal beam assembly.

FIG. 4 shows the lifting fixture of FIG. 2 with its substantially vertical structural assembly and its upper horizontal beam assembly exploded to reveal a septum plate common to both of these assemblies, and also defining cutting planes A-A for FIG. 5a, B-B for FIG. 5b, C-C for FIG. 6a, D-D for FIG. 6b, and E-E for FIG. 7a.

FIG. 5a shows a cross section view of the substantially vertical structural assembly taken at plane A-A of FIG. 4.

FIG. 5b shows a cross section view of the substantially vertical structural assembly taken at plane B-B of FIG. 4.

FIG. 6a shows a cross section view of the upper horizontal beam assembly taken at plane C-C of FIG. 4.

FIG. 6b shows a cross section view of the upper horizontal beam assembly taken at plane D-D of FIG. 4.

FIG. 6c shows a stylized representation of an alternative arrangement of lifting affordance components residing in the upper horizontal beam assembly of the lifting fixture of FIG. 2.

FIG. 7a shows a cross section view of the lower horizontal beam assembly taken at plane E-E of FIG. 4.

FIG. 7b shows a cross section view of an alternative embodiment for the lower horizontal beam assembly taken at plane E-E of FIG. 4.

FIG. 8 shows an oblique top front right view of the lower horizontal beam assembly of the lifting fixture of FIG. 2, with one of the plate components omitted and another of the plate components exploded upward to reveal other internal structural elements.

FIG. 9a shows an oblique top front right view of a distal portion of the lower horizontal beam assembly of the lifting fixture of FIG. 2 engaged with a conveyor pulley assembly.

FIG. 9b shows components of the lifting fixture assembly and the conveyor pulley of FIG. 9a exploded for further discussion.

FIG. 10a shows an oblique top front left view of an alternative embodiment of a lifting fixture in accordance with the invention.

FIG. 10b shows an oblique top front left view of the lifting fixture of FIG. 10a with some of its components exploded to reveal internal components and structures.

FIG. 10c shows an oblique top rear left view of the lifting fixture of FIG. 10a, with some of the components of FIG. 10b omitted and further internal and structural components exploded for discussion.

FIG. 10d shows an oblique top rear left view of the lifting fixture of FIG. 10a, with some of the components of FIG. 10c omitted and further internal and structural components exploded for discussion.

FIG. 10e shows an oblique top front left view of the lifting fixture of FIG. 10a, with some of the components of FIG. 10d omitted and further internal and structural components exploded for discussion.

FIG. 10f shows an oblique top front left view of the lifting fixture of FIG. 10a, with some of the components of FIG. 10e omitted and further internal and structural components exploded for discussion.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise, and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise. Also in this specification, the term “means for . . . ” as used herein including the claims, is to be interpreted according to 35 USC 112 paragraph 6.

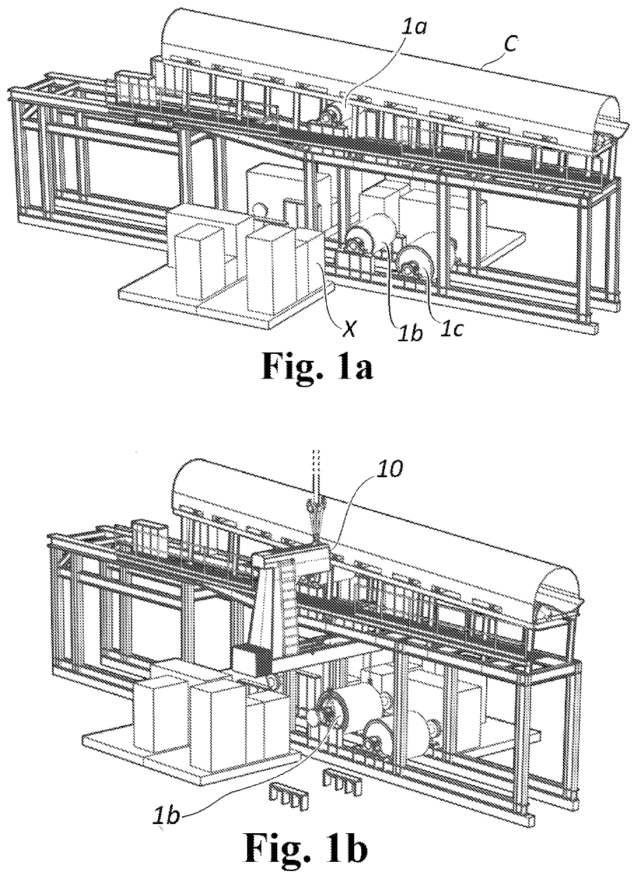

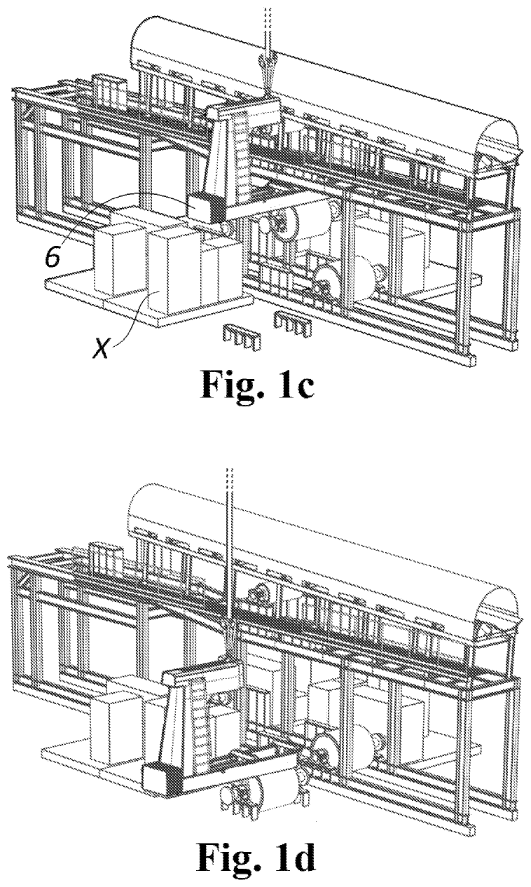

Referring now to the figures, FIG. 1a shows an environmental view of a physical plant which includes conveying equipment [C] and conveyor belt pulleys [1a,] [1b,] and [1c] as stored components. Other equipment cabinets [X] such as for electrical breaker panels, switch gear, programmable controllers and the like may also confine or obstruct the pulleys and make access to them difficult for overhead lifting devices such as vehicular cranes or bridge cranes in a large physical plant. Besides conveyor pulleys, replaceable motors and paper mill rollers are also examples of heavy or bulky replaceable machine components which may be stored in confined spaces lacking ready overhead access for lifting hooks from cranes.

FIG. 1b shows an embodiment of a lifting fixture [10] in accordance with the invention positioned to engage and raise a conveyor pulley [1b] from a storage location underneath a conveyor belt structure. The axis of vertical lifting for the fixture is offset to the side of the lifting axes applied to the pulley even though it is located directly below substantial overhead conveying structures.

FIG. 1c shows the lifting fixture of FIG. 1b with the conveyor pulley raised up from its storage location and maintained level even while the lifting axis of the overhead crane is offset from the center of gravity of the pulley. The mass of the counterweight [6] is selected so that the center of gravity of the lifting fixture, with or without its load, remains substantially offset from the midpoint of its lower beam assembly. The hoists on the lower beam of the lifting fixture are thus able to engage and raise or manipulate large bulky components directly beneath overhead obstructions while the line of action or lifting line of the crane supporting the inventive lifting fixture remains outside and clear of the overhead structures. A large counterweight also reduces twisting of the lifting fixture when the mass of its load is added. The invention also delivers local raising and lowering capabilities in confined areas not reachable by a vehicular crane or bridge crane even where the lifting task must be done in a space crowded by other obstructions such as electrical cabinets [X.]

FIG. 1d shows the lifting fixture of FIG. 1b having successfully moved the conveyor pulley from an obstructed storage or service location to an open-area maintenance or inspection area, even while surrounded by other obstructions.

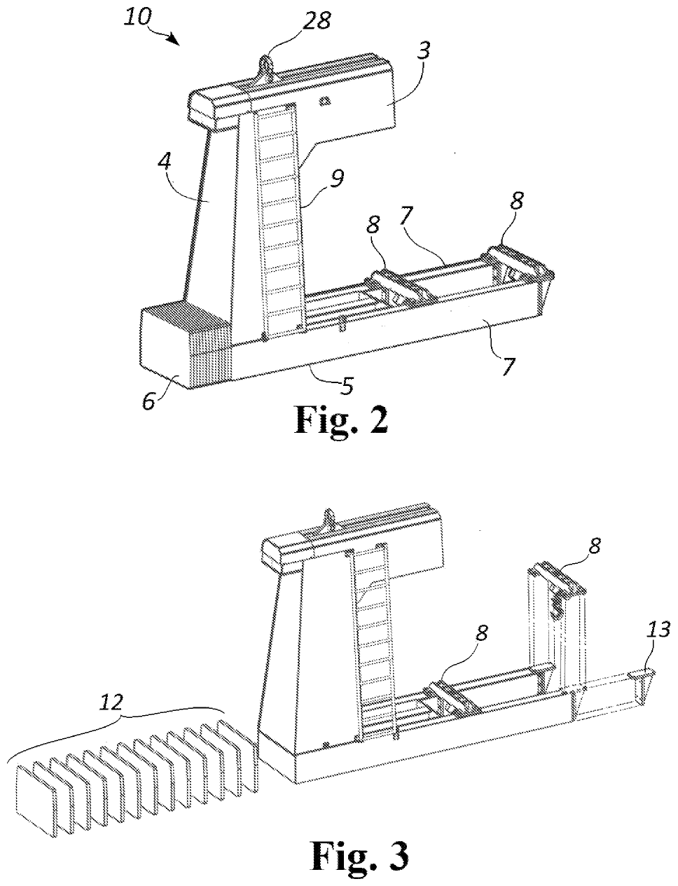

FIG. 2 shows an oblique top front left view of an embodiment of a lifting fixture [10] in accordance with the invention. The lifting fixture comprises a first horizontal beam assembly [3] and a second horizontal beam assembly [5] each having first and second proximal ends where a substantially vertical structural assembly [4] spans between the first end of the first beam assembly and the first end of the second beam assembly. A counterweight [6] is affixed proximal to the juncture of the first end of the second horizontal beam assembly and the substantially vertical structural assembly. The second horizontal beam assembly includes at least one hoist [8.] The lifting fixture may be manufactured to any effective and useful size and may thus include a ladder affixed to a substantially vertical portion of its structure to provide access to the mechan-isms within the upper beam assembly which translate the lifting affordance along a length of the upper beam. A lifting affordance in this specification is a component or feature which defines and provides a lifting site or attachment point for a crane, hook, chain, or rope. A preferred lifting affordance is a lifting eye or a clevis, a hook, or a carabiner passed through a hole in a plate.

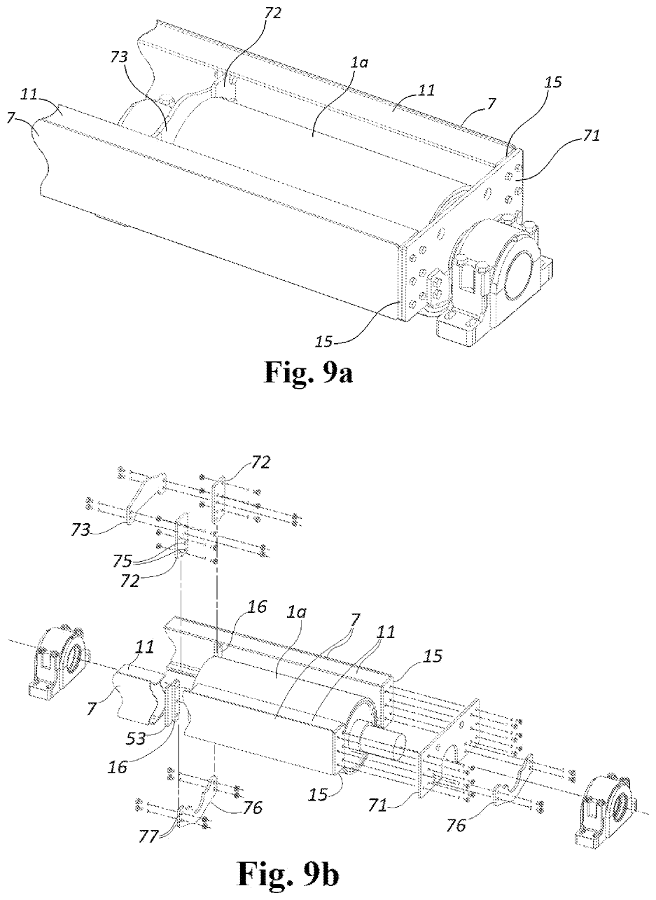

Another way to describe the lifting fixture is to recite that it comprises a lifting affordance [28] slidingly coupled to a first horizontal beam assembly, a second assembly [5] comprising two spaced-apart horizontal beams defining an intervening gap, with these horizontal beams further comprising pluralities of threaded apertures for receiving a plurality of adapter plates (as further illustrated in FIGS. 8, 9a, and 9b) and a substantially vertical structural assembly [4] connecting a first end of the first horizontal beam assembly to a first end of the second assembly. The beams in this embodiment are I-channels which are reinforced with plates [7.] In addition to its ordinary meaning in this specification the phrase “substantially vertical” means any structure extending or having a longitudinal axis extending within 35 degrees of geometric vertical, which includes any vertical direction perpendicular to a horizon and any vertical direction parallel to a direction of force exerted by a local gravitational field.

FIG. 3 shows the lifting fixture of FIG. 2 with its counterweight being a linear array of plates [12] shown exploded in this view, and one of its two hoists [8] and one of its beam tip hoist adapter fixtures [13] exploded from its lower horizontal beam assembly. This lower beam assembly includes two spaced-apart horizontal beams, and the hoists are attached proximate to the gap between the beams. The hoist may be an assembly which includes flange or ridge features so that when they are installed securely onto the lower beam assembly they further stabilize the beams like a “strongback” tie used in construction framing.

The attachment interface between the beam tips and their adapter fixtures is a modular interface, which means that definitions for locations, positional tolerances, fastener features, and fastener receiving features such as threaded apertures, are standardized. New adapters may be designed for new equipment at any time by incorporating the pre-defined modular attachment features into any sort of bracket, bogie, or carrying plate which will also incorporate complementary features specific to the equipment to be lifted and manipulated by the fixture. Thus, if the tip fixture [13] is designed to space apart the lifting hooks of the two hoists for a certain component having two defined lifting points a certain distance apart, and a similar new component is required which having a longer distance between its lifting points, a new pair of tip fixtures may be designed and fabricated having the same fastener patterns for securing it to the lower beams of the lifting fixture, but having fastener patterns for the other hoist spaced further apart by the same additional distance.

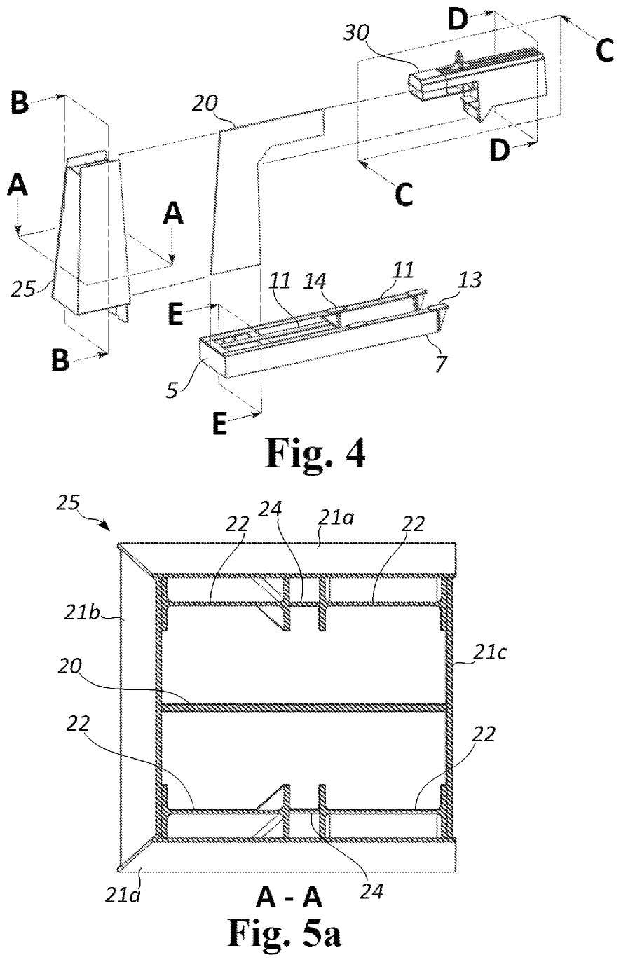

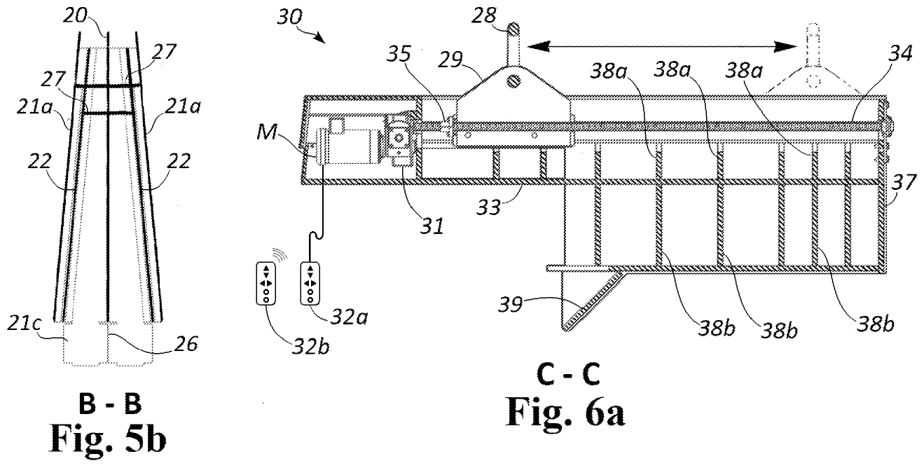

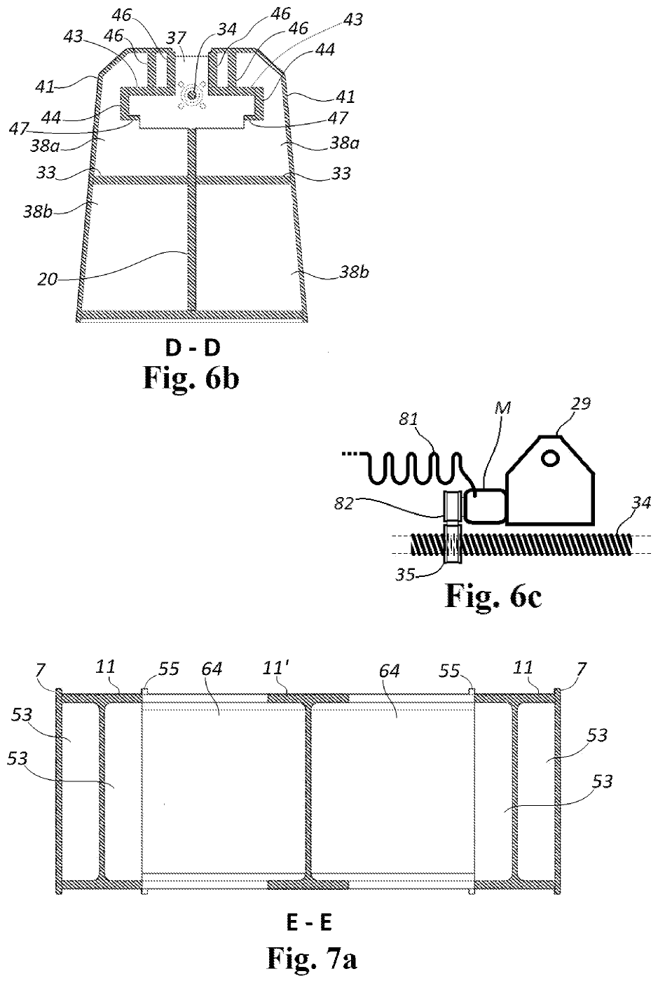

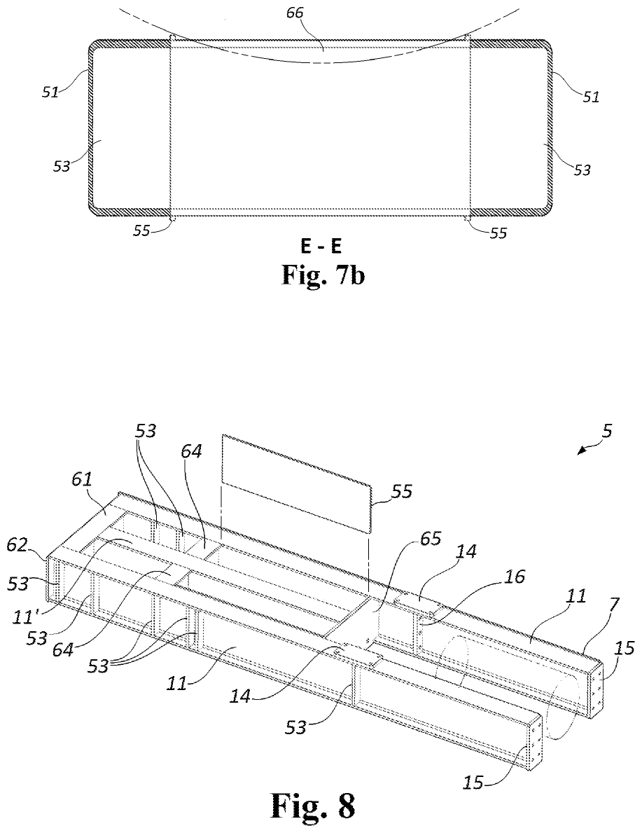

FIG. 4 shows the lifting fixture of FIG. 2 with its substantially vertical structural assembly [25] and its upper horizontal beam assembly [30] exploded to reveal a septum plate [20] common to both of these assemblies, and also defining cutting planes A-A for FIG. 5a, B-B for FIG. 5b, C-C for FIG. 6a, D-D for FIG. 6b, and E-E for FIG. 7a. The septum plate resides within a midplane of the first horizontal beam assembly and a midplane of the substantially vertical structural assembly, and is also affixed to a medial or central structural component of the lower beam assembly [5] which in this embodiment is an I-channel [11.] The two spaced-apart beams which support the hoists, or which may also embrace a component to be lifted, are also I-beams in this embodiment. These two beams include first attachment sites [14] for a proximal hoist and second attachment sites [13] for a distal hoist, and they are built up from structural channels and reinforced with additional plates [7.]

FIG. 5a shows a cross section view of the substantially vertical structural assembly [25] taken at plane A-A of FIG. 4. For trapezoidal exterior plates, two of type [21a] and one each of type [21b] and [21c] form a hollow beam resembling an obelisk or pyramid. Two pairs of I-beams [22] are welded interior of the two type [21a] plates and an additional plate [24] connects the two I-beams of each pair, residing in the plane of the web sections of the I-beams. The septum plate [20] resides in a midplane of the entire structure.

FIG. 5b shows a cross section view of the substantially vertical structural assembly taken at plane B-B of FIG. 4. The septum plate [20] resides in a midplane of the entire structure. The pairs of I-beams [22] are closed by exterior plates [21a] welded to their flanges. Bending moments from the offset load must be transferred to the upper beam assembly, so the upper portion of this vertical structural assembly includes transverse plates [27] which align with other planar components of the upper beam shown and discussed in FIG. 6a. At least one structural plate [21c] in this assembly extends into the lower beam assembly and includes a cruciform slot [26] complementary to the exterior contour of an I-beam in the lower beam assembly, so that a complete perimeter weld of this plate to that I-beam creates and exceptionally robust and well-integrated path for lifting forces applied by the lower beam assembly to flow into the planar membrane sections of the vertical structural assembly.

FIG. 6a shows a cross section view of the upper horizontal beam assembly [30] taken at plane C-C of FIG. 4. This beam assembly comprises a motor [M] for translating a lifting affordance along a substantial portion of the length of the beam assembly. In this embodiment the lifting affordance is a lifting eye [28] secured to a slideable plate [29.] The beam assembly has a first threaded component [34] defining an axis of translation threadingly engaged to a second threaded component [35] translatable along the same axis. In this embodiment the lifting affordance is coupled to the second threaded component and the motor is operationally coupled to the first threaded component for rotation by the motor's output or drive shafts. Some motors are mechanical sub-assemblies which include reduction gearing [31.] The motor may be controllable by an umbilically attached control module [32a] or by a wireless device [32b.] Structurally, this beam assembly includes a horizontal spine [33] preferably contiguous or affixed to one of the transverse plates [27 of FIG. 5b] of the vertical structural assembly. Lifting forces are collected by a plurality of vertical plates [38a] above the spine which are preferably aligned with a complementary array of vertical plates [38b] which are spaced apart along the length of the beam assembly and ending with an end plate [37.] An angled member [39] follows and is welded to a chamfer in the contour of the septum plate seen in FIG. 4.

In this embodiment the first threaded component is a threaded rod with a power thread which may be a single or a multiple-pitch lead screw. This component is rotatable by the motor and the sliding plate has a second, female-threaded component engaged with the power screw. When the power screw rotates, the plate slides the lifting eye along the length of the upper beam assembly. The sliding plate may also rest upon or be guided by longitudinal rails or structural guide surfaces within this upper assembly.

FIG. 6b shows a cross section view of the upper horizontal beam assembly taken at plane D-D of FIG. 4. The septum plate [20] resides in a midplane of the entire structure. A horizontal spine [33] spans the length of the beam assembly at about mid-height in this section. A plurality of vertical plates [38a] are affixed above the spine which are preferably aligned with a complementary array of vertical plates [38b] which are spaced apart along the length of the beam assembly and ending with an end plate [37] which includes a support bearing for the distal end of the power screw [34] which moves the lifting eye and its plate (not shown.) The spine and plate internal structures are enclosed by sidewalls [41.] Rather than have this rotatable rod support the entire combined weight of the fixture itself plus the component being moved, the upper beam assembly includes support rails [43] with underside surfaces for rollers or sliding surfaces of the lifting affordance and its support plate. The rail channel also includes lateral guides [44] and floor rails [47] for supporting the lifting affordance when the fixture is not in use. Vertically oriented rail channel splines [46] provide added sectional strength for lifting forces and withstanding bending moments from laterally offset loads.

FIG. 6c shows a stylized representation of an alternative arrangement of lifting affordance components residing in the upper horizontal beam assembly of the lifting fixture of FIG. 2. Although FIG. 6a shows a configuration wherein the motor is coupled to the first threaded component for rotation thereof and the second threaded component is a female threaded nut fixed against rotation as the lifting affordance translates along the axis of a rotating power screw, it is also possible to arrange the components so that the motor [M] is attached to the lifting affordance plate [29] and rotates the second, female threaded component [35] while the first threaded component is a threaded rod [34] fixed against rotation. The motor may use sheaves [82] and a belt drive or may use sprockets and silent chain or the second threaded component may include gear teeth engaged with a spur gear mounted on the motor shaft. The motor may receive power and commands by an umbilical cord or cable [81,] or the rail system for supporting and sliding the slidable plate may include energized rails for supplying motor power or command signals, or both. Thus, according to this optional configuration shown, the lifting fixture may have its second threaded component rotatable with the motor operationally coupled to the second threaded component.

FIG. 7a shows a cross section view of the lower or second horizontal beam assembly taken at plane E-E of FIG. 4. This assembly is built up of joists which are structural channels and plates welded together. The outer beams are structural channels such as I-beams [11,] and they are additionally reinforced with plates [7] parallel to the central web of the beam cross section. Interior facing cavity areas of these I-beams are also closed off with reinforcing plates [55.] Similar to the upper beam assembly cross section seen in FIG. 6a, a plurality of vertical plates [53] are spaced apart along the length of this beam assembly. The center joist [11′] is shorter than the outer joists, and its end face also abuts a single or a left and right pair of end plates which close off the internal volumes of the lower beam assembly and is also attached to transverse structural members. This particular configuration comprises three joists, with the middle one having its center web centered within the cross section of the assembly, so that a midplane of the assembly passes through the web portion of this joist. The septum plate is preferably welded to this joist coplanar to this midplane. A structure of two or three beams works better to allow the lower assembly to remain substantially rigid while lifting or embracing the component to be transported.

FIG. 7b shows a cross section view of an alternative embodiment for the lower horizontal beam assembly taken at plane E-E of FIG. 4. This configuration may be used for a lighter lifting fixture assembly in accordance with the invention or for reduced cost. The two outer, longer horizontal beams [51] of the assembly are made from C-channels or deep flange U-channels, of which the exposed distal potions are closed by plates [55] visible beyond the plane of this cross section view. As with the planar members [38a] and [38b] of FIG. 6a, and the vertical plates [53] of FIG. 7a, a plurality of transverse ribs are welded along the length of the beams to collect bending moment stresses and transfer these to the vertical beam assembly when under load. An end plate [66] closes off the internal volumes of the lower beam assembly of this particular set of embodiments. A phantom line curve depicts the lower portion of a large round or cylindrical object being embraced by the two outer horizontal beams for lifting in a manner similar to how two tines of a forklift may be spaced apart for lifting and transporting a load object such as a horizontally oriented drum, storage tank, or a conveyor pulley by approaching such an object with the tines from beneath.

FIG. 8 shows an oblique top front right view of the lower horizontal beam assembly [5] of the lifting fixture of FIG. 2, with one of the plate components omitted and another of the plate components [55] exploded upward to reveal other internal structural elements. The lower horizontal beam assembly includes two longer I-beams [11] spaced apart to receive either strongback hoists affixed from above for engaging and lifting a component load below the fixture, or for accepting modular adapter plates for securing particular components having their own lifting points or sites adapted to engage with lifting fixtures particularly designed for them.

A central, shorter I-beam [11′] resides with its central web at the midplane of the assembly as defined by the symmetry of the structure as seen in the cross section view FIG. 7a. The septum plate is preferably welded to this central beam coplanar with this midplane. The proximal end is closed by a transverse I-beam [61] and its flange is closed by an end plate [62.] The counterweight is attached to this end of the lower beam. Another transverse I-beam [64] is aligned proximal to plate [21c] seen in FIG. 5a of the vertical beam assembly. A plurality of stiffening ribs [53] fill in the flanges and webs of the I-beams of the assembly and these are disposed at locations where lifting forces are acquired such as in the vicinity of attachment sites [14] for the hoists or sites [16] for the adapter plates, bending moment is transferred from, and also located or may be concentrated where bending moments are to be transferred to the vertical beam assembly. The distal end of the shorter, central I-beam is closed by another end plate [65.] The outward facing flanges of the two longer I-beams are closed by side plates [7] of which one is removed for clarity in this figure. The two longer I-beams end with adapter plate receiving sites [15] which include modular attachment features such as through hole arrays or threaded hole arrays for receiving beam tip extensions or fixtures for securing particular component loads to the invention. Besides transporting one or more auxiliary hoists for lifting objects (such as a drum or pulley) beneath the fixture and suspending them by the hoists for transit, the invention is also useful for approaching objects endwise and at or below the top of the object so that the lower beams bestride the object from a horizontal direction at or below the top of the object to allow for lifting in or near confined spaces.

FIG. 9a shows an oblique top front right view of a distal portion of the lower horizontal beam assembly of the lifting fixture of FIG. 2 engaged with a conveyor pulley [1a] assembly which includes its pillow blocks or shaft bearings. The two longer I-beams [11] of the lower beam assembly have their outward facing flanges closed by plates [7] which add sectional strength in the bending direction of these beams. The adapter plate receiving sites [15] at the beam ends receive threaded fasteners which secure a conveyor roller upper carry plate [71.] Another such carry plate [72] is secured to a dedicated adapter plate [72] which attaches to transverse ribs [16 of FIGS. 8 and 9b] of the lower beam assembly.

FIG. 9b shows components of the lifting fixture assembly and the conveyor pulley of FIG. 9a exploded for further discussion. The conveyor roller [1a] is part of an assembly which includes its pillow blocks or bearings which are shown axially exploded from their shaft ends. Distal portions of the two longer I-beams [11] of the lower beam assembly with their outward facing flanges closed by plates [7] are shown with the foreground beam cut away to reveal a modular attachment site plate [16] reinforced with a rib [53] coplanar to it on the opposite side of the I-beam web.

Two lateral modular adapter plates [72] each include a first set of apertures for engagement to the modular attachment site, and a second set for engagement to carry plates adapted to secure the particular type of conveyor roller shown as the example component. On the proximal end of the roller assembly, an upper carry plate [73] attaches to the modular adapter plate and it includes a surface which bears against or closely constrains a portion of the shaft of the conveyor roller assembly. A lower carry plate [76] includes attachment sites [77] for securing to the lateral modular adapter plates at their own dedicated sites [75,] and it includes a concave surface which embraces and constrains an underside portion of shaft of the conveyor roller assembly. For the distal end of the conveyor roller assembly, another adapter plate [71] includes first sets of modular aperture arrays for engagement to the adapter plate receiving sites [15] at the beam ends, and a second set of apertures for a second lower carry plate [76.] When the system of adapter plates is assembled as desired, the entire conveyor roller assembly may be pulled from service or storage or installed simply by its connection sites on the pillow blocks.

Although the adapter plate system shown in the previous figures was designed for a particular sort of conveyor roller as an assembly with its pillow blocks it will be appreciated that many other configurations for adapter plates may be judiciously devised for lifting and moving all sorts of industrial equipment and components. Adapter fixtures for use with the inventive lifting fixture preferably include modular attachment features in common with each other, and specific features adapted to align with particular lifting sites specific to the components being worked on. Examples of these specific features include lifting eyes on pumps, generators, batteries, fans, transformers, and stationary engines, compressors, chemical storage tanks, formed-wire cages, and gaylord containers.

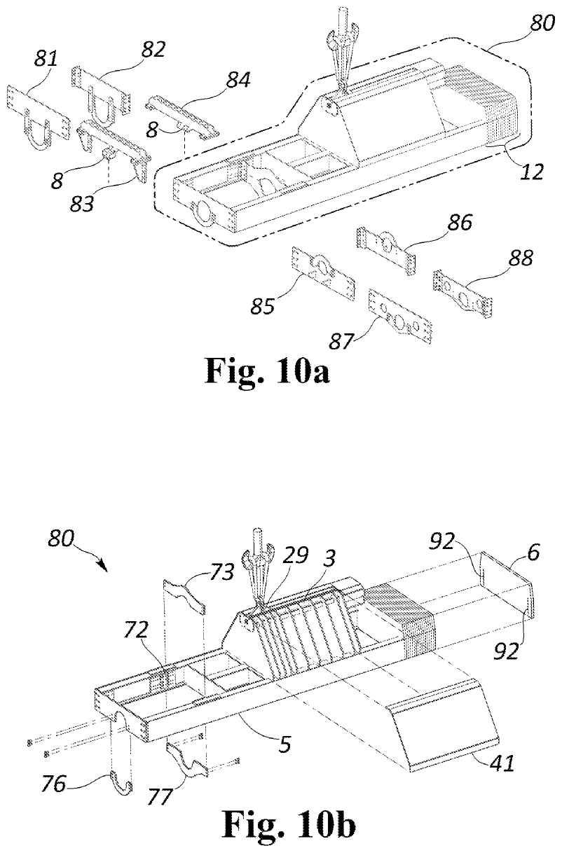

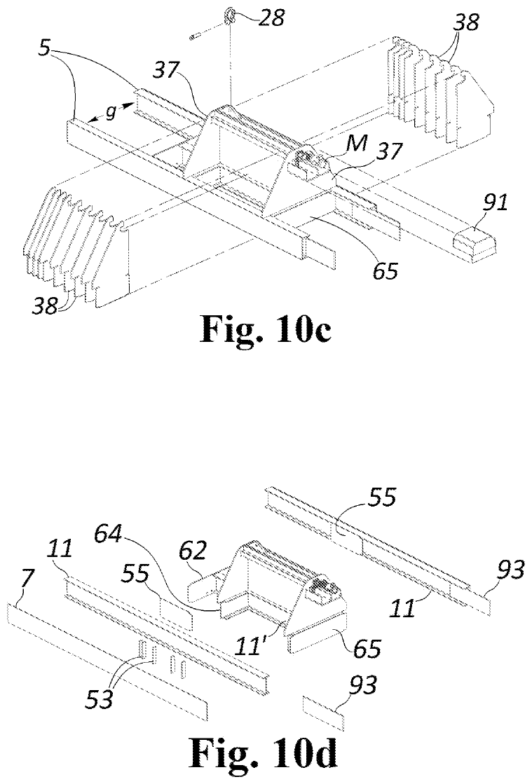

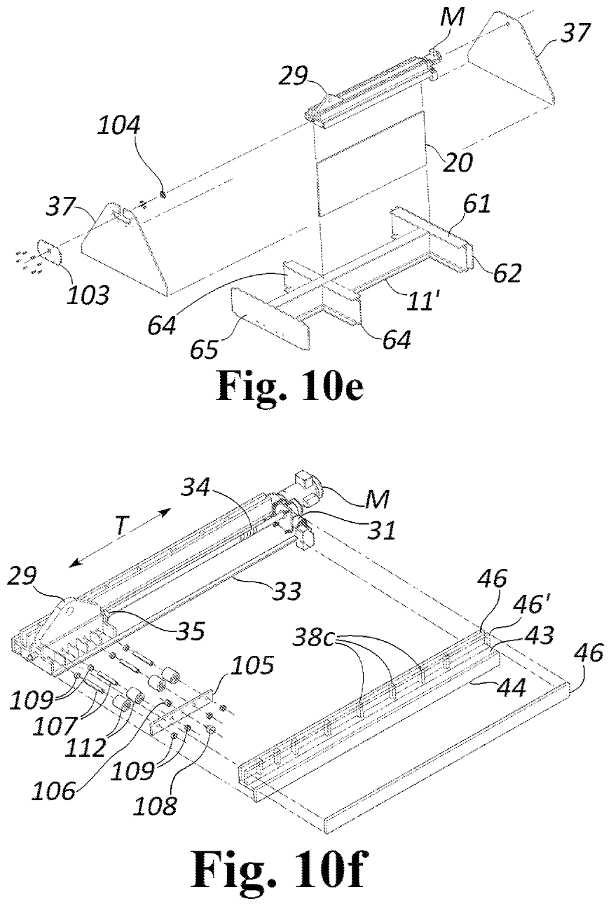

FIG. 10a shows an oblique top front left view of an alternative embodiment of a lifting fixture [80] in accordance with the invention. The counterweight [12] is adjustably built up from a plurality of longitudinally stacked plates. Threaded fixtures in the longitudinally extending pairs of lifting arms may be configured to accept various adapter sets for raising and lowering different sorts of equipment from conveyor rollers as seen previously, or any other bulky or difficult to handle equipment typically stored in covered framing where access for direct vertical lifting is obstructed.

In this figure, besides the standard pulley lifting fixture shown installed, front and rear adapters [81] and [82] have deeper yokes. Rigging strongbacks [83] and [84] may include one or more hoists [8] as shown. Adapters may also be fashioned such as [85] and [86] wherein the cross member passes beneath the axis of a machine or component being lifted and upper straps secure the component to the lifting fixture from above. Other alternative fixtures such as [87] and [88] depicted here may include more than one axle-supporting aperture so that more than one small diameter component may be transported simultaneously.

FIG. 10b shows an oblique top front left view of the lifting fixture [80] of FIG. 10a with some of its components exploded to reveal internal components and structures. The assembly shown comprises a first horizontal beam assembly [3] and a second horizontal beam assembly [5,] with each having first and second proximal ends by the motor end of the first beam assembly. A lifting affordance [29] is slidingly coupled to the first horizontal beam assembly. The horizontal beams of the second beam assembly further comprise pluralities of threaded apertures for receiving the various adapter plates [72,] cradle components [73,] and various yokes [76] and [77.]

A counterweight affixed proximal to a juncture of the first end of the second horizontal beam assembly and the substantially vertical structural assembly is revealed by exploding away side plate [41.] The counterweight is built up of plates [6] having apertures or slots [92] which rest upon a pair of support forks.

FIG. 10c shows an oblique top rear left view of the lifting fixture of FIG. 10a, with some of the components of FIG. 10b omitted and further internal and structural components exploded for discussion. Spaced apart vertical plates [38] form part of a substantially vertical structural assembly spanning between the first end of the first beam assembly and the second beam assembly [5] which comprises two spaced-apart horizontal beams defining an intervening gap [g.] The first horizontal beam assembly further comprises a motor [M.] The motor may be controlled by a wireless device. When hoist fixtures [83] and [84] of FIG. 10a are installed and deployed, the assembly may be configured with at least one hoist positioned proximate to the gap between the two spaced-apart horizontal beams of the second beam assembly. The lifting affordance as shown in this figure is equipped with a shackle [28] and its locking screw pin.

FIG. 10d shows an oblique top rear left view of the lifting fixture of FIG. 10a, with some of the components of FIG. 10c omitted and further internal and structural components exploded for discussion. The second beam assembly of this embodiment comprises a pair of laterally spaced apart joists or I-channels [11] reinforced with additional plates [7.] A central joist [11′] resides in the midplane of the vertical structure that connects the first and second beam assemblies. A plurality of stiffening ribs [53] fill in the flanges and webs of the I-beams of the assembly and these are disposed at locations where bending stresses in the beam fabrications are high. In this type of embodiment, the second horizontal beam assembly comprises at least three joists; a central joist [11′] and two symmetrically built lateral joists [11.] Inward-facing portions of interior facing cavity areas of the I-beams are also closed off with reinforcing plates [55.] The proximal end of the middle joist is closed off by a first end plate [65] and the distal end is closed by a second end plate [62.] Another transverse I-beam [64] is aligned proximal to the distal end plate of the vertical structural assembly, and in preferable embodiments is aligned with its web coplanar with one of the end plates of the substantially vertical structural assembly. A set of slotted counterweight plates are hung on the two support ribs [93] which are affixed to and extend from the proximal ends of the lateral joists of the second beam assembly.

FIG. 10e shows an oblique top front left view of the lifting fixture of FIG. 10a, with some of the components of FIG. 10d omitted and further internal and structural components exploded for discussion. The substantially vertical structural assembly further comprises a septum plate [20] residing within a midplane of the first horizontal beam assembly and a midplane of the substantially vertical structural assembly. The vertical assembly includes two end plates [37,] the distal one of which includes a bearing support plate [103] for holding the distal bearing [104] of the power screw or threaded rod that translates the lifting affordance [29.]

The septum plate of the second horizontal beam assembly is preferably welded to a central joist [11′] coplanar with this midplane so that the midplane passes through a web portion of the central joist. The proximal end is closed by a transverse I-beam [61] and its flange is closed by an end plate [62.] The distal end of the middle joist is closed off by end plate [65] and another transverse I-beam [64] is aligned proximal to the distal end plate of the vertical structural assembly.

FIG. 10f shows an oblique top front left view of the lifting fixture of FIG. 10a, with some of the components of FIG. 10e omitted and further internal and structural components exploded for discussion. The first beam assembly of this embodiment comprises a pair of built-up sections each comprising three beams [43,] [44,] and [46.] The left-side portion of beam assembly is exploded and one of its beams [46] is shown further exploded laterally, with a second instance of the beam [46′] shown in phantom lines in registration with the other two. The built up beam sections each include a bottom flange [33] and are further reinforced by internal ribs [38c] spaced along and concentrated where bending moments or structural loads are greater.

The first horizontal beam assembly comprises a motor [M] operably coupled to a first threaded component [34] defining an axis of translation [T] and threadingly engaged to a second threaded component [35] translatable along that axis, and a lifting affordance [29] coupled to the second threaded component. The motor may be directly coupled to the first threaded component for rotation thereof, or a may include a gearbox [31] wherein the first threaded component is rotatable and the motor is operationally coupled to the first threaded component. Also alternatively, the rotatable and stationary threaded components for translating the lifting affordance may be reversed as seen in FIG. 6c wherein the second threaded component is rotatable and the motor is operationally coupled to the second threaded component.

The lifting affordance includes inverted “skate” assemblies that transfer the lifting load through rollers [112] supported on axles [107] which press into structural ribs [105] that include apertures for receiving journals or roller bearings [109.] The axle support ribs may be welded to the first beam assembly or secured by threaded fasteners such as [106] and [108.]

Other objects such as gate valves and lengths of process piping typically include flanges with circular arrays of bolt holes, and these may be secured in part or in their entirety by adapter plates which are then secured to the modular attachment sites of the lifting fixture. Process piping in particular is often designed as densely nested structures of adjacent sections having concentric arcs or closely spaced parallel runs of pipe. The inventive lifting fixture serves as a very useful tool for safely and precisely handling and exchanging these sorts of industrial components in densely crowded or confined spaces.

With increasing transitions from hydrocarbon-fueled engines to electrical machinery powered by replaceable and rechargeable batteries, the same challenge will exist for battery banks in scaffolded recharging stations, or warehouses of racks or shelving for inventory storage, wherein the invention provides utility for accessing and positioning items beneath shelves and in other locations where access for vertical lifting means is obstructed.

While certain features and aspects have been described with respect to exemplary embodiments, one skilled in the art will recognize that numerous modifications are possible. Also, while certain functionality is ascribed to certain system components, unless the context dictates otherwise, this functionality may be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Furthermore, the procedures described with respect to one method or process may be incorporated within other described methods or processes; likewise, system components described according to a particular structural configuration and/or with respect to one system may be organized in alternative structural configurations and/or incorporated within other described systems.

The present disclosure is not to be limited in terms of the particular embodiments described in this application, which are intended as illustrations of various aspects. Many modifications and variations may be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled.

Hence, while various embodiments are described with or without certain features for ease of description and to illustrate exemplary aspects of those embodiments, the various components and/or features described herein with respect to a particular embodiment may be substituted, added, and/or subtracted from among other described embodiments, unless the context dictates otherwise. Thus, unauthorized instances of apparatuses and methods claimed herein are to be considered infringing, no matter where in the world they are advertised, sold, offered for sale, used, possessed, or performed.

Consequently and in summary, although many exemplary embodiments are described above, it will be appreciated that the invention is intended to cover all modifications and equivalents within the scope of the following claims.

What is claimed is:

1. A lifting fixture, comprising
first and second horizontal beam assemblies each having first and second proximal ends,
a substantially vertical structural assembly spanning between said first end of said first beam assembly and said second beam assembly,
with said first beam assembly further comprising a first threaded component defining an axis of translation threadingly engaged to a second threaded component translatable along said axis, and
a lifting affordance coupled to said second threaded component.

2. The lifting fixture of claim 1, wherein said first horizontal beam assembly further comprises a motor.

3. The lifting fixture of claim 2, wherein said first threaded component is rotatable and said motor is operationally coupled to said first threaded component.

4. The lifting fixture of claim 2, wherein said second threaded component is rotatable and said motor is operationally coupled to said second threaded component.

5. The lifting fixture of claim 2, wherein said motor is controllable by a wireless device.

6. The lifting fixture of claim 1, further comprising a septum plate residing within a midplane of said first horizontal beam assembly and a midplane of said substantially vertical structural assembly.

7. The lifting fixture of claim 1, further comprising a counterweight affixed proximal to a juncture of said first end of said second horizontal beam assembly and said substantially vertical structural assembly.

8. The lifting fixture of claim 1, wherein said second horizontal beam assembly further comprises a midplane passing through a web portion of a joist.

9. The lifting fixture of claim 1, wherein said second horizontal beam assembly further comprises at least three joists.

10. The lifting fixture of claim 1, wherein said second horizontal beam assembly further comprises a hoist.

11. A lifting fixture comprising
a lifting affordance slidingly coupled to a first horizontal beam assembly,
a second assembly comprising two spaced-apart horizontal beams defining an intervening gap,
said horizontal beams of said second assembly further comprising pluralities of threaded apertures for receiving a plurality of adapter plates, and
a substantially vertical structural assembly connecting a first end of said first horizontal beam assembly to said second assembly.

12. The lifting fixture of claim 11, wherein said first horizontal beam assembly comprises
a motor and
a first threaded component defining an axis of translation threadingly engaged to a second threaded component translatable along said axis, with said lifting affordance coupled to said second threaded component.

13. The lifting fixture of claim 12, wherein said motor is coupled to said first threaded component for rotation thereof.

14. The lifting fixture of claim 12, wherein said motor is coupled to said second threaded component for rotation thereof.

15. The lifting fixture of claim 12, wherein said motor is controllable by a wireless device.

16. The lifting fixture of claim 11, further comprising a septum plate residing within a midplane of said first horizontal beam assembly and a midplane of said substantially vertical structural assembly.

17. The lifting fixture of claim 11, further comprising a counterweight affixed proximal to a juncture of said first end of said second assembly and said substantially vertical structural assembly.

18. The lifting fixture of claim 11, further comprising at least one hoist deposed proximate to said gap between said two spaced-apart horizontal beams of said second assembly.
